(19) United States
(12) Patent Application Publication
(10) Pub. No.: US 2023/0205070 A1
(43) Pub. Date: Jun. 29, 2023

(54) DUAL REFLECTIVE MICRO PROJECTION OPTICAL ENGINE

(71) Applicant: IVIEW DISPLAYS (SHENZHEN) COMPANY LTD., Shenzhen (CN)

(72) Inventors: Xiaofeng Tang, Shenzhen (CN); Mingnei Ding, Shenzhen (CN); Weizhan Zhu, Shenzhen (CN); Steve Yeung, Hongkong (CN); Zhiqiang Gao, Hongkong (CN)

(21) Appl. No.: 17/973,595

(22) Filed: Oct. 26, 2022

(30) Foreign Application Priority Data
Dec. 23, 2021 (CN) 202111592375.8

(51) Int. Cl. G03B 21/20; G02B 5/04; G02B 27/12; G02B 27/30; G02B 13/00; G02B 3/00

(52) U.S. Cl. CPC G03B 21/2066; G02B 5/04; G03B 21/208; G02B 27/12; G02B 27/30; G02B 13/001; G02B 3/0056

(57) ABSTRACT

The present disclosure provides a dual reflective micro projection optical engine. The dual reflective micro projection optical engine includes a light source and a DMD chip, and a collimating light-combining module, a fly-eye lens, a reflective mirror, a diopter prism, a prism assembly, and a projection lens that are successively disposed in a light exit direction of the light source.

### CROSS-REFERENCE TO RELATED APPLICATIONS

This application is based upon and claims priority to Chinese Patent Application No. 202111592375.8, filed with the National Intellectual Property Administration of China on Dec. 23, 2021, and entitled “DUAL REFLECTIVE MICRO PROJECTION OPTICAL ENGINE”, the entire contents of which are incorporated herein by reference.

### TECHNICAL FIELD

Embodiments of the present disclosure relate to the technical field of micro projector engines, and in particular, relate to a dual reflective micro projection optical engine.

### BACKGROUND

Since a projection image of a projector provides a wide field of view for users, the projector becomes more and more popular among users. With the development of electronic and multimedia technologies, users are imposing higher and higher requirements on projectors, and the projectors develop towards miniaturization and lightweight while the projection effect of the projectors is being continuously optimized, such that the users can easily carry the projector and enjoy a visual effect of large screen anytime and anywhere.

During the practice of embodiments of the present disclosure, the present inventors have found that the related art has at least the following problems. Conventional projectors have a large size and are inconvenient for the users to carry, and directions of long and short sides of conventional optical engine are generally inconsistent with directions of long and short sides of a projection region, which limits application scenarios of a projection optical engine when a placement direction of the projection optical engine is required to be consistent with a direction of a target illumination region.

### SUMMARY

An embodiment of the present disclosure provides a dual reflective micro projection optical engine. The dual reflective micro projection optical engine includes: a light source, configured to output illumination light, wherein the illumination light is transmitted along a first direction; a collimating light-combining module, disposed in a light exit direction of the light source; a fly-eye lens, disposed in a light exit direction of the collimating light-combining module, wherein the illumination light passes through the collimating light-combining module and the fly-eye lens and is continuously transmitted along the first direction; a reflective mirror, disposed in a light exit direction of the fly-eye lens, and configured to carry out a first adjustment on the direction of the illumination light; a diopter prism, including a light incident surface, a light reflective surface, and a light exit surface, wherein the light incident surface is disposed in a light exit direction of reflected light of the reflective mirror, and the diopter prism is configured to carry out a second adjustment on a direction of the illumination light and output illumination light transmitted along a second direction; a DMD chip, configured to receive the illumination light and generate image light; a prism assembly, a light incident side of the prism assembly being disposed in a light exit direction of the diopter prism and a light reflective side of the prism assembly being disposed in a light exit direction of the DMD chip, wherein the prism assembly is configured to reflect the illumination light to the DMD chip, and receive image light generated by the DMD chip and causes the image light to exit via the light exit side; and a projection lens, a light incident side of the projection lens being disposed in a light exit direction of the prism assembly, wherein the projection lens is configured to adjust the image light and cause the image light to exit.

Another embodiment of the present disclosure provides a micro projection optical engine. The micro projection optical engine includes: a light source, configured to output illumination light; a collimating light-combining module, disposed in a light exit direction of the light source; a fly-eye lens, disposed in a light exit direction of the collimating light-combining module, wherein the illumination light passes through the collimating light-combining module and the fly-eye lens and is continuously transmitted along a first direction; a reflective mirror, disposed in the light exit direction of the fly-eye lens, and configured to carry out a first adjustment on a direction of the illumination light; a diopter prism, including a light incident surface, a light reflective surface, and a light exit surface, wherein the light incident surface is disposed in a light exit direction of reflected light of the reflective mirror, and the diopter prism is configured to carry out a second adjustment on a direction of the illumination light and output illumination light transmitted along a second direction opposite to the first direction; a DMD chip, configured to receive the illumination light and generate image light; a prism assembly, a light incident side of the prism assembly being disposed in a light exit direction of the diopter prism and a light reflective side of the prism assembly being disposed in a light exit direction of the DMD chip, wherein the prism assembly is configured to reflect the illumination light to the DMD chip, and receive image light generated by the DMD chip and causes the image light to exit via the light exit side; and a projection lens, a light incident side of the projection lens being disposed in a light exit direction of the prism assembly, wherein the projection lens is configured to adjust the image light and cause the image light to exit.

### BRIEF DESCRIPTION OF THE DRAWINGS

One or more embodiments are illustrated by way of example, and not by limitation, in the figures of the accompanying drawings, wherein elements/modules having the same reference numeral designations represent like elements/modules throughout. The drawings are not to scale, unless otherwise disclosed.

FIG. 1 is a schematic structural view of a dual reflective micro projection optical engine according to an embodiment of the present disclosure.

FIG. 2 is a schematic view illustrating structures and optical paths of a DMD chip and a prism assembly in FIG. 1.

FIG. 3 is a schematic view of a projection effect of a dual reflective micro projection optical engine according to an embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of devices, and in some occasions, module division different from the divisions of the modules in the devices may be used. Further, the terms “first,” “second,” “third,” “fourth,” “fifth,” and the like used in this text do not limit data and execution sequences, and are intended to distinguish identical items or similar items having substantially the same functions and effects. As used herein, the terms “left,” “right,” and the like expressions are used for illustration purposes only.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

Specifically, hereinafter, the embodiments of the present disclosure are further illustrated with reference to the accompanying drawings.

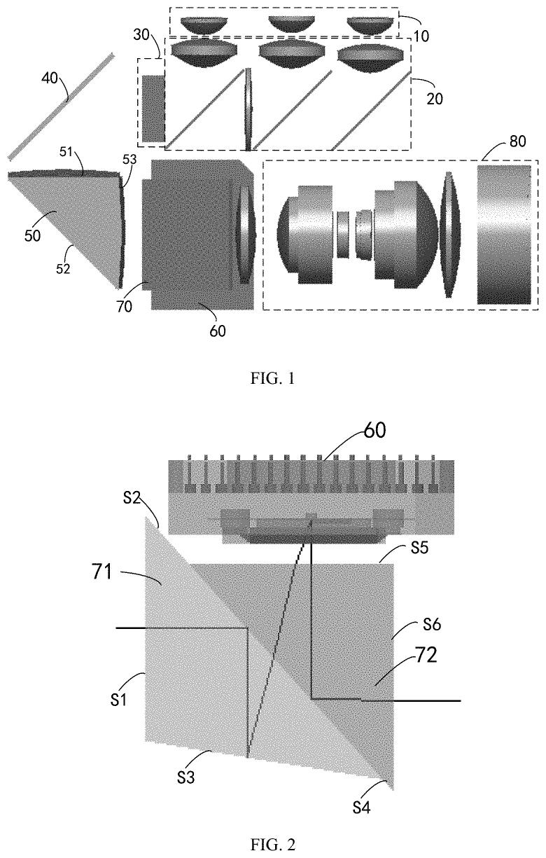

An embodiment of the present disclosure provides a dual reflective micro projection optical engine. Referring to FIG. 1 and FIG. 2, FIG. 1 illustrates a structure of a dual reflective micro projection optical engine according to an embodiment of the present disclosure, and FIG. 2 illustrates structures and optical paths of a DMD (digital micromirror device) chip and a prism assembly in FIG. 1. The dual reflective micro projection optical engine includes: a light source 10, a collimating light-combining module 20, a fly-eye lens 30, a reflective mirror 40, a diopter prism 50, a DMD chip 60, a prism assembly 70, and a projection lens 80.

The light source 10 is configured to output illumination light, wherein the illumination light may be transmitted along a first direction. The light source 10 may be a laser light source or a light-emitting diode (LED) light source or the like, which may be selected according to actual needs. In an example illustrated in FIG. 1, the first direction is a right-to-left direction, and the second direction is a left-to-right direction.

The collimating light-combining module 20 is disposed in a light exit direction of the light source 10. The collimating light-combining module 20 is configured to collimate light, and combine R light, G light, and B light output from the light source 10 and cause the combined light to exit. Specifically, the structure of the collimating light-combining module 20 may be designed according to actual needs, which is not limited to the example illustrated in FIG. 1.

The fly-eye lens 30 is disposed in a light exit direction of the collimating light-combining module 20, wherein the illumination light passes through the collimating light-combining module and the fly-eye lens and is continuously transmitted along the first direction. In some embodiments, the fly-eye lens 30 is a fly-eye diffuser lens, and the fly-eye lens 30 diffuses the illumination light and causes the diffused illumination light to exit.

The reflective mirror 40 is disposed in the light exit direction of the fly-eye lens 30, and configured to carry out a first adjustment on a direction of the illumination light. Specifically, the reflective mirror 40 may be a planar mirror, or a non-planar mirror. Specifically, structural configurations defining whether the reflective mirror 40 is a planar mirror and the curvature in the case that the reflective mirror 40 is a non-planar mirror may be designed according to actual needs, which are not limited to those in the embodiments of the present disclosure.

The diopter prism 50 includes a light incident surface 51, a light reflective surface 52, and a light exit surface 53, wherein the light incident surface 51 is disposed in a light exit direction of reflected light of the reflective mirror 40, and the diopter prism 50 is configured to carry out a second adjustment on a direction of the illumination light and output illumination light transmitted along a second direction. The first direction is opposite to the second direction. Specifically, the light incident surface 51 and the light exit surface 53 of the diopter prism 50 are planar surfaces or curved surfaces. The light reflective surface 52 of the diopter prism 50 is coated with a highly-reflective film, or, the illumination light is incident via the light incident surface 51 of the diopter prism 50 into the diopter prism 50, and an incident angle of the illumination light reaching the reflective surface 52 of the diopter prism 50 is greater than a total internal reflection (TIR) critical angle of the diopter prism 50. According to the embodiment of the present disclosure, the folding and direction adjustment of illumination light are achieved by using the reflective mirror 40 and the diopter prism 50, which can effectively save costs, facilitate the installation and fixation, and effectively reduce installation tolerance.

The DMD chip 60 is configured to receive the illumination light and generate image light. The DMD chip 60 is a core of digital light processing (DLP), which is capable of receiving the illumination light and adjusting a switching frequency to generate the image light for projection imaging.

A light incident side of the prism assembly 70 is disposed in a light exit direction of the diopter prism 50 and a light reflective side of the prism assembly 70 is disposed in a light exit direction of the DMD chip 60, and the prism assembly 70 is configured to reflect the illumination light to the DMD chip 60, and receive image light generated by the DMD chip 60 and cause the image light to exit via the light exit side.

Specifically, the prism assembly 70 includes a first prism 71 and a second prism 72. The first prism 71 includes a first surface 51, a second surface S2, and a third surface S3, wherein the illumination light is incident into the first prism 71 via the first surface 51, and is totally reflected via the second surface S2 to the third surface S3 and reflected to the second surface S2 for transmissive exit. The third surface S3 is capable of adjusting an angle of the illumination light, such that the illumination light reaches the second surface S2 with an incident angle less than a total reflection angle, thereby causing the light to be transmitted and exit. By adjusting an included angle β defined between the second surface S2 and the third surface S3, the light may be incident onto the DMD chip 60 at a correct angle. In some embodiments, an included angle α defined between the first surface 51 and the second surface S2 of the first prism 71 is 45°±20°, and the third surface S3 of the first prism 71 is a spheric surface, an aspheric surface, or a freely-curved surface. In some embodiments, the first surface 51 is coated with a highly-transparent film, the second surface S2 is coated with a semi-reflective and semi-transparent film, the third surface S3 is coated with a highly-reflective film, and the film may be a metal film or a dielectric film.

The second prism 72 includes a fourth surface S4, a fifth surface S5, and a sixth surface S6, wherein the fourth surface S4 and the second surface S2 are integrally fitted, the fifth surface S5 is disposed proximally to the DMD chip 60, the illumination light is incident into the second prism 72 via the fourth surface S4 and irradiated onto the DMD chip 60 upon exiting via the fifth surface S5, and the image light generated by the DMD chip 60 is incident into the second prism 72 via the fifth surface S5 and totally reflected via the fourth surface S4 to the sixth surface S6 for exit. In some embodiments, the fourth surface S4 is coated with a semi-reflective and semi-transparent film, the fifth surface S5 and the sixth surface S6 are each coated with a highly-transparent film, and the film may be a metal film or a dielectric film. Further, the second prism 72 may be an isosceles right-angled prism.

A light incident side of the projection lens 80 is disposed in a light exit direction of the prism assembly 70, and the projection lens 80 is configured to adjust the image light and cause the image light to exit. Specifically, the projection lens 80 is disposed proximally to the sixth surface S6, and configured to adjust the light to a suitable size, and/or to address possible distortion problems of the image light, and/or may also be configured to adjust a focal length and the like of the image. The specific structure of the projection lens 80, for example, the set number of lenses, and the model, material and the like of the lenses, may be designed according to actual functional needs on the projection lens 80, which is not limited to the example in the embodiment illustrated in FIG. 1.

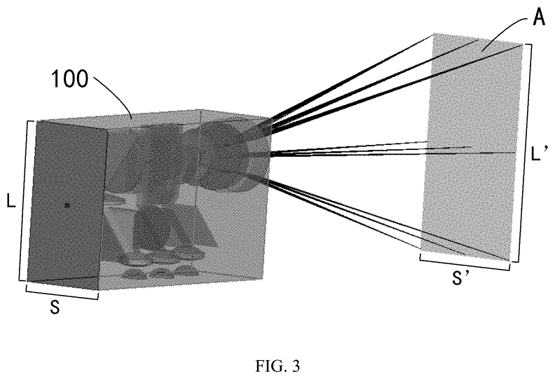

Referring to FIG. 3, FIG. 3 illustrates a projection effect of a dual reflective micro projection optical engine 100 according to an embodiment of the present disclosure. As illustrated in FIG. 3, an embodiment of the present disclosure provides a DLP dual reflective micro projection optical engine system with a compact layout, small size, and convenient portability. In addition, when a placement direction of the projection optical engine is required to be consistent with a direction of a target illumination region A, a long side L of the dual reflective micro projection optical engine according to the embodiment of the present disclosure corresponds to a field side L′ of the target illumination region, and likewise, a short side S of the dual reflective micro projection optical engine corresponds to a short side S′ of the illumination region.

The embodiments of the present disclosure provide a dual reflective micro projection optical engine with a compact layout, small size, and convenient portability. The dual reflective micro projection optical engine includes a light source and a DMD chip, and a collimating light-combining module, a fly-eye lens, a reflective mirror, a diopter prism, a prism assembly, and a projection lens that are successively disposed in a light exit direction of the light source. According to the present disclosure, an optical path direction of the illumination light is adjusted by the reflective mirror and the diopter prism and an optical path direction of the image light is adjusted by an optical path design of the DMD chip and the prism assembly, such that directions of long and short sides of a projection region are maintained consistent with directions of long and short sides of the projection optical engine in the case that the exited image light is projected and imaged.

It should be noted that the above described device embodiments are merely for illustration purpose only. The units which are described as separate components may be physically separated or may be not physically separated, and the components which are illustrated as units may be or may not be physical units, that is, the components may be deployed in the same position or may be distributed into a plurality of network units. Part or all of the modules may be selected according to the actual needs to achieve the objects of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A dual reflective micro projection optical engine, comprising:
a light source, configured to output illumination light, wherein the illumination light is transmitted along a first direction;
a collimating light-combining module, disposed in a light exit direction of the light source;
a fly-eye lens, disposed in a light exit direction of the collimating light-combining module, wherein the illumination light passes through the collimating light-combining module and the fly-eye lens and is continuously transmitted along the first direction;
a reflective mirror, disposed in the light exit direction of the fly-eye lens, and configured to carry out a first adjustment on a direction of the illumination light;
a diopter prism, comprising a light incident surface, a light reflective surface, and a light exit surface, wherein the light incident surface is disposed in a light exit direction of reflected light of the reflective mirror, and the diopter prism is configured to carry out a second adjustment on a direction of the illumination light and output illumination light transmitted along a second direction.
a DMD chip, configured to receive the illumination light and generate image light;
a prism assembly, a light incident side of the prism assembly being disposed in a light exit direction of the diopter prism and a light reflective side of the prism assembly being disposed in a light exit direction of the DMD chip, wherein the prism assembly is configured to reflect the illumination light to the DMD chip, and receive image light generated by the DMD chip and causes the image light to exit via the light exit side; and
a projection lens, a light incident side of the projection lens being disposed in a light exit direction of the prism assembly, wherein the projection lens is configured to adjust the image light and cause the image light to exit.

2. The dual reflective micro projection optical engine according to claim 1, wherein the light incident surface and the light exit surface of the diopter prism are planar surfaces.

3. The dual reflective micro projection optical engine according to claim 1, wherein the light incident surface and the light exit surface of the diopter prism are curved surfaces.

4. The dual reflective micro projection optical engine according to claim 1, wherein the reflective surface of the diopter prism is coated with a highly-reflective film.

5. The dual reflective micro projection optical engine according to claim 1, wherein the illumination light is incident via the light incident surface of the diopter prism into the diopter prism, and an incident angle of the illumination light reaching the reflective surface of the diopter prism is greater than a total internal reflection critical angle of the diopter prism.

6. The dual reflective micro projection optical engine according to claim 1, wherein the first direction is opposite to the second direction.

7. The dual reflective micro projection optical engine according to claim 1, wherein the prism assembly comprises:
a first prism, comprising a first surface, a second surface, and a third surface, wherein the illumination light is incident into the first prism via the first surface, and is totally reflected via the second surface to the third surface and reflected to the second surface for transmissive exit; and
a second prism, comprising a fourth surface, a fifth surface, and a sixth surface, wherein the fourth surface and the second surface are integrally fitted, the fifth surface is disposed proximally to the DMD chip, the illumination light is incident into the second prism via the fourth surface and irradiated onto the DMD chip upon exiting via the fifth surface, and the image light generated by the DMD chip is incident into the second prism via the fifth surface and totally reflected via the fourth surface to the sixth surface for transmissive exit.

8. The dual reflective projection optical engine according to claim 7, wherein the first surface, the fifth surface, and the sixth surface are each coated with a highly-transparent film; the second surface and the fourth surface are each coated with a semi-reflective and semi-transparent film; and the third surface is coated with a highly-reflective film.

9. The dual reflective projection optical engine according to claim 7, wherein the second prism is an isosceles right-angled prism.

10. The dual reflective projection optical engine according to claim 7, wherein an included angle α defined between the first surface and the second surface of the first prism is 45°±20°, and the third surface of the first prism is a spheric surface, an aspheric surface, or a freely-curved surface.

11. A micro projection optical engine, comprising:
a light source, configured to output illumination light;
a collimating light-combining module, disposed in a light exit direction of the light source;
a fly-eye lens, disposed in a light exit direction of the collimating light-combining module, wherein the illumination light passes through the collimating light-combining module and the fly-eye lens and is continuously transmitted along a first direction;
a reflective mirror, disposed in the light exit direction of the fly-eye lens, and configured to carry out a first adjustment on a direction of the illumination light;
a diopter prism, comprising a light incident surface, a light reflective surface, and a light exit surface, wherein the light incident surface is disposed in a light exit direction of reflected light of the reflective mirror, and the diopter prism is configured to carry out a second adjustment on a direction of the illumination light and output illumination light transmitted along a second direction opposite to the first direction;
a DMD chip, configured to receive the illumination light and generate image light;
a prism assembly, a light incident side of the prism assembly being disposed in a light exit direction of the diopter prism and a light reflective side of the prism assembly being disposed in a light exit direction of the DMD chip, wherein the prism assembly is configured to reflect the illumination light to the DMD chip, and receive image light generated by the DMD chip and causes the image light to exit via the light exit side; and
a projection lens, a light incident side of the projection lens being disposed in a light exit direction of the prism assembly, wherein the projection lens is configured to adjust the image light and cause the image light to exit.

12. The micro projection optical engine according to claim 11, wherein the light incident surface and the light exit surface of the diopter prism are planar surfaces.

13. The micro projection optical engine according to claim 11, wherein the light incident surface and the light exit surface of the diopter prism are curved surfaces.

14. The micro projection optical engine according to claim 11, wherein the reflective surface of the diopter prism is coated with a highly-reflective film.

15. The micro projection optical engine according to claim 11, wherein the illumination light is incident via the light incident surface of the diopter prism into the diopter prism, and an incident angle of the illumination light reaching the reflective surface of the diopter prism is greater than a total internal reflection critical angle of the diopter prism.

16. The micro projection optical engine according to claim 11, wherein the prism assembly comprises:
a first prism, comprising a first surface, a second surface, and a third surface, wherein the illumination light is incident into the first prism via the first surface, and is totally reflected via the second surface to the third surface and reflected to the second surface for transmissive exit; and
a second prism, comprising a fourth surface, a fifth surface, and a sixth surface, wherein the fourth surface and the second surface are integrally fitted, the fifth surface is disposed proximally to the DMD chip, the illumination light is incident into the second prism via the fourth surface and irradiated onto the DMD chip upon exiting via the fifth surface, and the image light generated by the DMD chip is incident into the second prism via the fifth surface and totally reflected via the fourth surface to the sixth surface for transmissive exit.

17. The projection optical engine according to claim 16, wherein the first surface, the fifth surface, and the sixth surface are each coated with a highly-transparent film; the second surface and the fourth surface are each coated with a semi-reflective and semi-transparent film; and the third surface is coated with a highly-reflective film.

18. The projection optical engine according to claim 16, wherein the second prism is an isosceles right-angled prism.

19. The projection optical engine according to claim 16, wherein an included angle α defined between the first surface and the second surface of the first prism is 45°±20°, and the third surface of the first prism is a spheric surface, an aspheric surface, or a freely-curved surface.
